(19) United States
(12) Patent Application Publication
(10) Pub. No.: US 2025/0307602 A1
(43) Pub. Date: Oct. 2, 2025

(54) ANOMALY DETECTION IN MONITORED COMPUTER SYSTEMS

(71) Applicant: CHECK POINT SOFTWARE TECHNOLOGIES LTD., TEL AVIV (IL)

(72) Inventors: Yosef BEN-SHLOMO, Givatayim (IL); Uri BEN-DOR, Kefar Saba (IL); Erez ISRAEL, Tel Aviv (IL); Ronen Nisan SHOHAT, Tel Aviv (IL)

(73) Assignee: CHECK POINT SOFTWARE TECHNOLOGIES LTD., TEL AVIV (IL)

(21) Appl. No.: 18/621,324

(22) Filed: Mar. 29, 2024

(51) Int. Cl. G06F 11/07; G06F 11/34; G06F 40/284

(52) U.S. Cl. CPC G06N 3/045

(57) ABSTRACT

A computer device and method are provided for detecting anomalies in a monitored computer system by classifying detected events using a machine learning model trained based on an activity log of events detected during an initial activity period. The machine learning model embeds logged events by generating a vector based on a tokenization of the logged event and a categorization of the logged event by a large language model. Events detected during the initial activity period are used to generate a profile of the monitored computer system. Events detected after the initial activity period are compared to the generated profile by a classifier of the machine learning model to classify each detected event as anomalous or normal.

### TECHNICAL FIELD

The present disclosure relates generally to anomaly detection and more particularly to anomaly detection in monitored computer systems using machine learning.

### BACKGROUND

Anomaly detection is important in safeguarding computer systems and networks from unauthorized access, data breaches, and various cyber threats. Anomaly detection aims to detect malware or other malicious activity by identifying unusual patterns or behaviors within a system that deviates from what is considered normal. These anomalies can range from simple misconfigurations to sophisticated cyber-attacks designed to exploit vulnerabilities within the system.

Traditionally, anomaly detection has been achieved through a variety of methods, including statistical models, threshold-based systems, and signature-based detection, each with its own set of advantages and limitations. However, detecting anomalies has grown more difficult with the exponential growth in complexity and volume of data within computer systems.

Traditional methods often struggle to keep pace with the dynamic and sophisticated nature of modern cyber threats, leading to high false positive rates and the inability to detect novel or zero-day attacks. This has underscored the need for more advanced and adaptable approaches capable of understanding and analyzing the vast and complex datasets characteristic of contemporary IT environments.

### SUMMARY

The present disclosure provides a device and method for detecting anomalies in a monitored computer system by classifying detected events using a machine learning model trained based on an activity log of events detected during an initial activity period.

While a number of features are described herein with respect to embodiments of the invention, features described with respect to a given embodiment also may be employed in connection with other embodiments. The following description and the annexed drawings set forth certain illustrative embodiments of the invention. These embodiments are indicative, however, of but a few of the various ways in which the principles of the invention may be employed. Other objects, advantages, and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention in which similar reference numerals are used to indicate the same or similar parts in the various views.

FIG. 1 is an exemplary diagram of a computer device for using a machine learning model to detect anomalies in a monitored computer system.

FIG. 2 is an exemplary diagram showing the generation of a profile of the monitored computer system by a machine learning model using events occurring during an initial activity time.

FIG. 3 is an exemplary diagram showing the classification of events occurring after the initial activity time using the machine learning model and the generated profile.

FIG. 4 is an exemplary flow diagram of a method performed by processor circuitry for using a machine learning model stored in memory to detect anomalies in a monitored computer system.

The present invention is described below in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

### DETAILED DESCRIPTION

The present disclosure provides a computer device and method for detecting anomalies in a monitored computer system by classifying detected events using a machine learning model trained based on an activity log of events detected during an initial activity period. The machine learning model embeds logged events by generating a vector based on a tokenization of the logged event and a categorization of the logged event by a large language model. Events detected during the initial activity period are used to generate a profile of the monitored computer system. Events detected after the initial activity period are compared to the generated profile by a classifier of the machine learning model to classify each detected event as anomalous or normal.

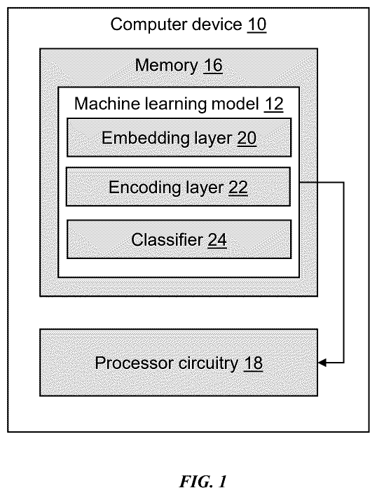

Turning to FIG. 1, a computer device 10 is shown for using a machine learning model 12 to detect anomalies in a monitored computer system. The monitored system may be at least one of a container, a pod, a virtual machine, (VM) or a physical computer. For example, the monitored computer system may be part of a larger system such as one managed by Kubernetes or a public cloud service such as Amazon Elastic Container Service (ECS). The computer device 10 includes a memory 16 (also referred to as a storage device) storing the machine learning model 12 and processor circuitry 18. As described in further detail below, the computer device 10 may be a part of the monitored computer system.

The machine learning model 12 includes an embedding layer 20 (also referred to as an embedding component), an encoding layer 22 (also referred to as an encoding component), and a classifier 24 (also referred to as a classifier component). The embedding layer 20 outputs a combination of an output of a large language model 26 and an output of a learned embedding layer 28. The encoding layer 22 outputs a profile 30 representing the role of the monitored computer system based on the output of the embedding layer after receiving as an input an initial activity log 36. The initial activity log 36 includes records of logged events 38 occurring during an initial activity period. The classifier 24 classifies events 38 occurring in the monitored computer system as anomalous or normal.

The processor circuitry 18 receives an activity log 36 including records of logged events 38 from the monitored computer system. The logged events 38 each represent and include information on at least one of a start of a process, a start of a thread, a termination of a process, a termination of a thread, or a start of a system call. Furthermore, each of the logged events includes event data comprising at least one of an identifier of the event, a type of the event, a parent of the event, a path of a binary related to the event, a path of the parent, an identifier of a user associated with the event, parameters of the event, a return value of the event, a priority of the event, a duration of the event, or a start time of the event.

For example, event data for a logged event 38 related to the start of a process may include: the name of the process, the ID of the process, the name of the parent process, the ID of the parent process, the path of the binary of the process, the path of the binary of the parent process, the name of the process user, the process user ID, the arguments of the process, the priority of the process, the absolute time of the start of the process, and the relative time of the start of the process in relation to the start of the monitored computer system.

As another example, event data for an event related to a system call may include: the type of system call (e.g. write, socket, etc.), the parameters of the system call, the return value of the system call, the duration of the system call, the absolute time of the system call, the relative time of the system call in relation to the start of the monitored computer system.

A logged event 38 may be represented in various formats including binary format as well as a string. For example, the logged event 38 may be formatted as a list of comma delimited type-value pairs, in JSON format or YAML format.

As described above, events 38 occurring during the initial activity period are identified in the initial activity log 36. The initial activity log 36 includes N logged events 38, where N is an integer greater than one. Similarly, each of the logged events 38 occurring after the initial activity period are identified as a subsequent logged event 38. The initial activity period is a predefined time duration. For example, the initial activity period may be a time duration beginning with initialization or provision of the monitored computer system. Alternatively, the initial activity period could begin on demand (e.g., based on user request). The length of the initial activity period may be any suitable duration of time (e.g., 24 hours, one week, one month, or any pre-configured period of time).

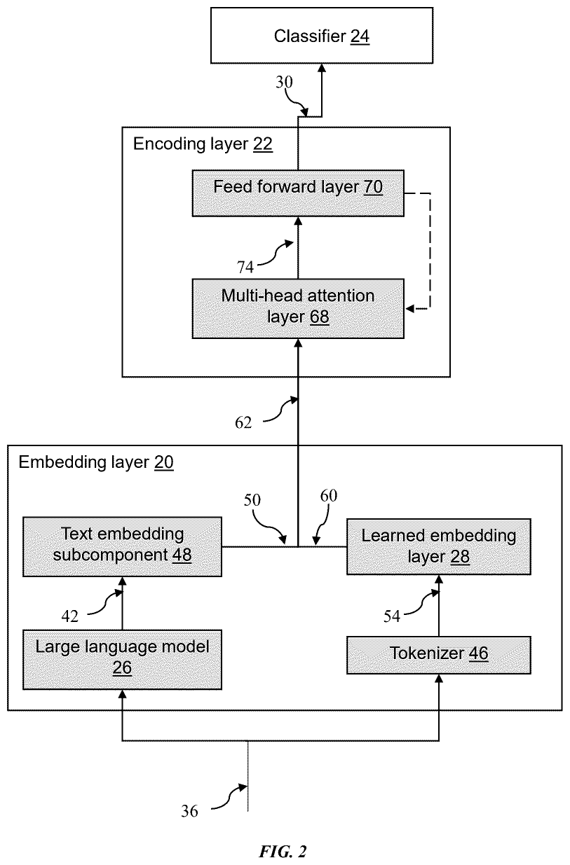

With exemplary reference to FIG. 2, the processor circuitry 18 applies the machine learning model 12 to the received initial activity log 36 by: (1) applying the embedding layer 20 to the initial activity log 36 to generate N d-dimensional numerical vectors; and (2) applying the encoding layer to the generated N d-dimensional numerical vectors to generate the profile.

The embedding layer 20 includes a large language model 26, a learned embedding layer 28 (also referred to as a trainable embedding layer), a tokenizer 46, and a text embedding subcomponent 48. Applying the embedding layer 20 includes applying the large language model 26 and the learned embedding layer 28 (after the tokenizer 46) to the initial activity log 36.

The embedding layer 20 applies the large language model 26 to each of the N logged events 38 to generate as an output N descriptions 42. Each of the N output descriptions 42 represents a logged event of the N logged events 38 that the output description 42 was generated from. The embedding layer 20 applies a text embedding subcomponent 48 to the N descriptions 42 to generate N fixed sized numerical vectors as N text embeddings 50. Each of the N fixed sized numerical vectors is a vector representation of a description of the N descriptions 42 that the fixed sized numerical vector was generated from. The text embedding sub-component 48 may be any suitable algorithm, such as a pre-trained text embedding module (e.g., Ada from OpenAI).

The large language model 26 may be any suitable large language model or natural language processing model for outputting a description of a logged event 38. For example, the large language model 26 may be implemented using pre-trained commercial large language models such as GPT3.5-Turbo, GPT4.0 or LLAMA. In addition to the logged event(s) 38, the large language model 26 may take as an input a prompt. For example, the prompt may be: “You are an assistant, skilled in explaining the purpose of process in a simple way. In addition, you are very punctual and always keep your answers at most {max_tokens} tokens long, but you also try to give the most information. Please explain the purpose of the corresponding process.” The term {max_tokens} in this prompt may serve as a placeholder for controlling the number of tokens (i.e., length of output) produced by the large language model 26.

Before applying the learned embedding layer 28, the embedding layer 20 applies a tokenizer 46 to the N logged events 38 to generate N vectors of tokens 54. Each token vector of the N vectors of tokens 54 represents a logged event of the N logged events 38. For example, each logged event of the N logged events 38 may be a string. The tokenizer 46 may use a map to tokenize the N logged events 38. The map includes multiple strings and each of the multiple strings is associated with a unique integer. The tokenizer 46 may be configured to tokenize each of the logged events 38 using the map. That is, when a logged event 38 is included in the map, the logged event 38 may be tokenized as vector of length 1 containing the unique integer associated with the logged event. Similarly, when the logged event 38 is not included in the map, the logged event 38 may be tokenized as a vector of length 1 containing a default integer.

The processor circuitry 18 applies the learned embedding layer 28 to the N vectors of tokens 54 to generate N fixed size numerical vectors as N learned embeddings 60. The learned embedding layer 28 may be implemented using any trainable embedding algorithm, such as PyTorch's embedding module.

The embedding layer 20 combines the N text embeddings 50 and the N learned embeddings 60 to generate the N d-dimensional numerical vectors 62 that are output to the encoding layer 22. The N text embeddings 50 and the N learned embeddings 60 may be combined to generate the N d-dimensional numerical vectors 62 by concatenating the N text embeddings 50 and the N learned embeddings 60, such that each of the N learned embeddings is concatenated with a text embedding of the N text embeddings that is associated with a same logged event of the N logged events. That is, the N text embeddings 50 and the N learned embeddings 60 may be joined so that the n-th vector of the N text embeddings 50 is concatenated to the n-th vector of the N learned embeddings 60 to create a list of N fixed size numerical vectors, each of size d.

The processor circuitry 18 applies the encoding layer 22 to generate the profile by contextualizing the N logged events 38 relative to one another. This is achieved by a sequence of operations including a multi-head attention layer 68, which processes the N d-dimensional numerical vectors 62, resulting in N d-dimensional attention vectors 74. Following the multi-head attention layer, a first add and normalize layer (also referred to as an add and norm layer) is applied, which combines the input of the encoding layer and the output of the multi-head attention layer through addition and normalization. A feed forward layer 70 may receive its input from the output of the first add and normalize layer and reduce before expanding a dimensionality of the N d-dimensional attention vectors 74. A second add and normalize layer may follow the feed forward layer, incorporating both the output of the first add and normalize layer and the feed forward layer through another round of addition and normalization. The profile 30 includes N d-dimensional profile vectors output by the second add and normalize layer. The profile may encode or represent the role of the monitored computer system based only on the initial activity log 36.

The encoding layer 22 may include at least two layers and applying the encoding layer 22 to the generated N d-dimensional numerical vectors 62 to generate the profile 30 may include sequentially applying the at least two layers of the encoding layer 22. That is, the output of the feed forward layer 70 may be passed from one layer to the multi-head attention layer 68 of a subsequent layer (represented by the dashed line in FIG. 2).

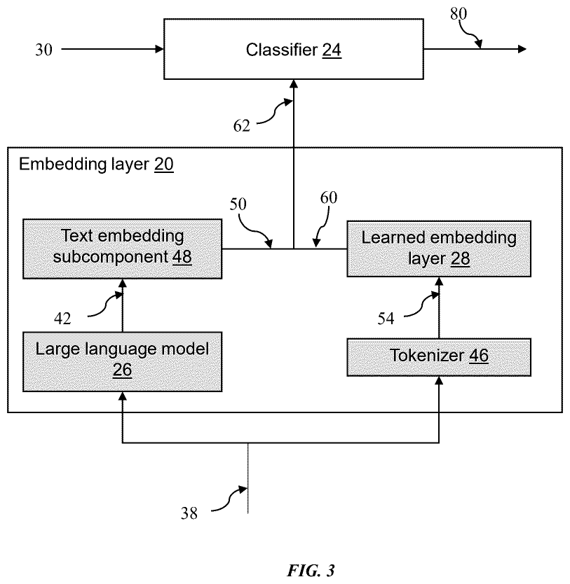

Turning to FIG. 3, handling of subsequent logged events (i.e., events occurring after the initial activity period) is shown. Following the initial activity period, the processor circuitry 18 applies the machine learning model to use the profile 30 to classify a subsequent logged event 38. To do so, the processor circuitry 18 applies the embedding layer 20 to the subsequent logged event 38 to generate a d-dimensional subsequent numerical vector 62.

To generate the subsequent numerical vector 62, the large language model 26 and tokenizer 46 are separately applied to the subsequent logged event 38. Applying the large language model 26 to the subsequent logged event 38 generates as an output a subsequent description 42. The embedding layer 20 then applies the text embedding subcomponent 48 to the subsequent description 42 to generate a subsequent fixed sized numerical vector as a subsequent text embedding 50.

Applying the tokenizer 46 to the subsequent logged event 38 generates a subsequent token vector 54. The subsequent learned embedding layer 28 is then applied to the subsequent token vector 54 to generate a subsequent fixed size numerical vector as a subsequent learned embedding 60. As described previously, the embedding layer 20 combines the subsequent text embedding 50 and the subsequent learned embedding 60 to generate a subsequent d-dimensional numerical vector 62. However, rather than applying the encoding layer 22 to the numerical vector 62, the classifier 24 is applied to the subsequent numerical vector 62.

The processor circuitry 18 applies the classifier 24 to compute a probability that the subsequent logged event 38 is anomalous or normal based on the generated profile 30 and the d-dimensional subsequent numerical vector 62 for the subsequent logged event 38. The processor circuitry 18 outputs the classification 80 of the subsequent logged event based on the computed probability. That is, the classifier 24 computes a probability that the logged event 38 is anomalous (also referred to as malicious). The classifier 24 may output this probability directly (e.g., the classification 80 may be the calculated probability) or in the alternative, the classifier 24 may check this probability against a pre-defined threshold to classify the logged event (e.g., as either anomalous or normal) and output this classification.

The classifier 24 may compute the probability based on the d-dimensional subsequent numerical vector and a head-wise weighted average vector. The head-wise weighted average vector may be calculated using the N d-dimensional profile vectors as the base for the average computation, while the output from a head-wise softmax function serves as the weight for this computation. Specifically, a multi-head attention analysis may be performed between the d-dimensional subsequent numerical vector and each of the Nd-dimensional profile vectors, generating N multi-head attention scores (i.e., one attention score for each of the N d-dimensional profile vectors). A head-wise softmax may then be computed for the N multi-head attention scores, generating N head-wise softmax vectors, which may act as weights. The head-wise weighted average may then be calculated by applying these weights to the N d-dimensional profile vectors, resulting in a d-dimensional head-wise weighted average vector. In this way, the N d-dimensional profile vectors may be averaged with the N head-wise softmax vectors providing the weights for this averaging. The resulting d-dimensional head-wise weighted average vector and the d-dimensional subsequent numerical vector may then be supplied to the classifier 24 as inputs.

The processor circuitry 18 may train the machine learning model 12. The machine learning model may be trained by receiving a training activity log including training logged events each classified as anomalous or normal. The training may further include modifying parameters of the embedding layer 20, the encoding layer 22, and the classifier 24 to minimize a loss function based on the training logged events. The loss function may be represented as follows:

$$Loss ( \vec{x} , \vec{y} ) = \frac{1}{{n}^{2}} \cdot {\sum }_{i , j = 1}^{n} - {( {y}_{i} - {y}_{j} )}^{2} \cdot log ( \frac{1 + ( {x}_{i} - {x}_{j} ) \cdot ( {y}_{i} - {y}_{j} )}{2} + ε ) + γ \cdot Relu ( \frac{1}{{n}^{2}} \cdot {( {\sum }_{i = 1}^{n} {x}_{i} - {y}_{i} )}^{2} - {δ}^{2} )$$

In the above equation, ε∈(0,0.001), δ ∈(0,0.25), γ>0, \vec{x} is the computed probability and is a vector of length n, y is the classification and is a vector of length n, and n≥8.

The training may additionally include generating the map used by the tokenizer 46 to tokenize the logged events 38. For example, the map may be initialized using the training activity log, where each unique logged event in the training activity log is assigned a unique integer.

The training activity log may be any suitable data for training the machine learning model 12. For example, the training activity log may include logged events collected on one or more real world monitored computer systems. The training activity log may include initial training activity logs (i.e., logged events generated during the initial activity period of monitored systems from which they originate) and subsequent training activity logs (i.e., all other logged events).

The training activity log may be fed into the machine learning model 12, where initial training activity logs are fed through the embedding layer, the encoder layer, and the classifier and where all the logged events of the subsequent training activity logs are fed individually through the embedding layer and the classifier. A combination of an initial training activity log and a later collected logged event may be labeled normal (also referred to as benign) if the later collected logged event was observed on the monitored computer system on which the initial training activity log originated from. Conversely, a combination of an initial training activity log and a later collected logged event may be labeled anomalous if the later collected logged event was not observed on the monitored computer system on which the initial training activity log originated from.

The activity log may be generated in any suitable manner. For example, The activity log may be generated by the monitored computer system and sent to the processor circuitry. As an example, events may be logged by an agent running on the monitored computer system. Alternatively, events may be logged by a remotely executed script (e.g., running periodically).

The activity log may be written locally on the monitored system, remotely on a network file system, or on an external storage service (e.g., AWS's Simple Storage Service (S3)). Locally written activity logs could be transmitted to a system external to the monitored computer system for further processing. The transmission of the activity logs may be initiated from the monitored computer system or pulled by a remote system (e.g., the computer device 10). The transmission of the activity logs may be done periodically.

In one embodiment, after training is completed, the machine learning model 12 may be deployed to detect anomalous behavior of one or more monitored computer systems. For that purpose, for each monitored computer system, an initial activity log of the monitored computer system may first be collected, and a profile of the monitored computer system may be generated. After the initial activity period, each logged event along with the monitored computer system's profile may be provided to the trained classifier to identify anomalous behavior. For example, the production of the profile and classification of logged events may be performed on the monitored computer system directly. That is, the computer device 10 may be a part of the monitored computer system. In the alternative, this classification may be performed external to the monitored computer system.

The profile 30 may be generated based on the initial activity log of one monitored computer system and the same profile may then be used to classify subsequent events on other monitored computer systems. For example, other monitored computer systems that are based on the same VM image or container image of the monitored computer system that the profile was generated from. The profile may also be applied to monitored computer systems comprising VMs and containers that are based off of subsequent VM images and container images (e.g. such as images that were slightly modified).

When an anomalous event is detected, the computer device 10 may take various action. For example, a log may be generated by the processor circuitry 18, a notification may be sent by the processor circuitry 18, the anomalous activity could be blocked, the monitored computer system could be stopped or quarantined, etc.

The processor circuitry 18 may have various implementations. For example, the processor circuitry 18 may include any suitable device, such as a processor (e.g., CPU, Graphics Processing Unit (GPU), Tensor Processing Unit (TPU), etc.), programmable circuit, integrated circuit, memory and I/O circuits, an application specific integrated circuit, microcontroller, complex programmable logic device, other programmable circuits, or the like. The processor circuitry 18 may also include a non-transitory computer readable medium, such as random-access memory (RAM), a read-only memory (ROM), an erasable programmable read-only memory (EPROM or Flash memory), or any other suitable medium. Instructions for performing the method described below may be stored in the non-transitory computer readable medium and executed by the processor circuitry 18. The processor circuitry 18 may be communicatively coupled to the computer readable medium and a network interface through a system bus, mother board, or using any other suitable structure known in the art.

The computer readable medium (memory) 16 may be, for example, one or more of a buffer, a flash memory, a hard drive, a removable media, a volatile memory, a non-volatile memory, a random-access memory (RAM), or other suitable device. In a typical arrangement, the computer readable medium 16 may include a non-volatile memory for long term data storage and a volatile memory that functions as system memory for the processor circuitry 18. The computer readable medium 16 may exchange data with the processor circuitry over a data bus. Accompanying control lines and an address bus between the computer readable medium 16 and the processor circuitry also may be present. The computer readable medium 16 is considered a non-transitory computer readable medium.

The computer device 10 may encompass a wide range of computing devices suitable for performing the disclosed functions and methods. This includes but is not limited to servers, desktop computers, network switches, routers, laptops, mobile devices, tablets, and any other computerized device capable of executing software instructions. The computer device 10 may include standard components such as a processor, memory, storage, input/output interfaces, and other necessary elements to execute the methods effectively.

Furthermore, the computer device 10 is not limited to a single device but may be embodied in a distributed computing environment. In such an environment, multiple interconnected devices may collaborate and work in unison to execute the computational steps of the methods and functions.

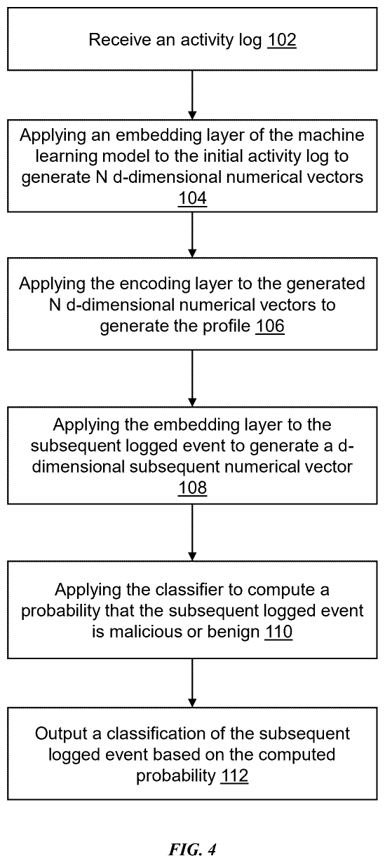

Turning to FIG. 4, a method 100 is shown for using the processor circuitry to apply a machine learning model stored in a non-transitory computer readable medium to detect anomalies in a monitored computer system. The method 100 involves processor circuitry executing the described steps to facilitate the classification process.

In step 102, the processor circuitry receives an activity log as described above. In combined steps 104 and 106, the processor circuitry applies a machine learning model stored in the non-transitory computer readable medium to the received initial activity log. In step 104, the processor circuitry applies an embedding layer of the machine learning model to the initial activity log to generate N d-dimensional numerical vectors. In step 106, the processor circuitry applying the encoding layer to the generated N d-dimensional numerical vectors to generate the profile by contextualizing the N logged events relative to one another by sequentially applying a multi-head attention layer and a feed forward layer to the Nd-dimensional numerical vectors.

In combined steps 108 and 110, the processor circuitry applies the machine learning model to a subsequent logged event. In step 108, the processor circuitry applies the embedding layer to the subsequent logged event to generate a d-dimensional subsequent numerical vector. In step 110, the processor circuitry applies the classifier to compute a probability that the subsequent logged event is anomalous or normal based on the generated profile and the d-dimensional subsequent numerical vector for the subsequent logged event.

In step 112, the processor circuitry outputs a classification of the subsequent logged event based on the computed probability.

The method 100 described herein may be performed using any suitable computerized device. For example, the method may be executed on a desktop computer, a laptop, a server, a mobile device, a tablet, or any other computing device capable of executing software instructions. The device may include a processor, memory, storage, input/output interfaces, and other standard components necessary for executing the method. The method 156 is designed to be platform-independent and can be implemented on various operating systems, such as Windows, macOS, Linux, or mobile operating systems like iOS and Android. Furthermore, the method may also be performed in a distributed computing environment, where multiple interconnected devices work collaboratively to execute the computational steps of the method.

All ranges and ratio limits disclosed in the specification and claims may be combined in any manner. Unless specifically stated otherwise, references to “a,” “an,” and/or “the” may include one or more than one, and that reference to an item in the singular may also include the item in the plural.

Although the invention has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A computer device for using a machine learning model to detect anomalies in a monitored computer system, the computer device comprising:
memory comprising a non-transitory computer readable medium storing the machine learning model, wherein the machine learning model includes:
an embedding layer configured to combine an output of a large language model and an output of a learned embedding layer;
an encoding layer configured to output a profile representing the role of the monitored computer system based on an initial activity log; and
a classifier configured to classify an event as anomalous or normal;
processor circuitry configured to:
receive an activity log comprising records of logged events each representing at least one of a start of a process, a start of a thread, a termination of a process, a termination of a thread, or a start of a system call, wherein:
each of the logged events includes event data comprising at least one of an identifier of the event, a type of the event, a parent of the event, a path of a binary related to the event, a path of the parent, an identifier of a user associated with the event, parameters of the event, a return value of the event, a priority of the event, a duration of the event, or a start time of the event;
each of the logged events occurring during an initial activity period are identified as the initial activity log comprising N logged events;
each of the logged events occurring after the initial activity period are identified as a subsequent logged event;
the initial activity period comprises a predefined time duration;
apply the machine learning model to the received initial activity log by:
applying the embedding layer to the initial activity log to generate N d-dimensional numerical vectors by:
applying the large language model to each of the N logged events to generate as an output N descriptions, wherein each of the N output descriptions represents a logged event of the N logged events that the output description was generated from;
applying a text embedding subcomponent of the embedding layer to the N descriptions to generate N fixed sized numerical vectors as N text embeddings, wherein each of the N fixed sized numerical vectors is a vector representation of a description of the N description that the fixed sized numerical vector was generated from;
applying a tokenizer of the embedding layer to the N logged events to generate N vectors of tokens, wherein each token vector of the N vectors of tokens represents a logged event of the N logged events;
applying the learned embedding layer to the N vectors of tokens to generate N fixed size numerical vectors as N learned embeddings; and
combining the N text embeddings and the N learned embeddings to generate the N d-dimensional numerical vectors;
applying the encoding layer to the generated N d-dimensional numerical vectors to generate the profile by contextualizing the N logged events relative to one another;
applying the machine learning model to a subsequent logged event by:
applying the embedding layer to the subsequent logged event to generate a d-dimensional subsequent numerical vector by:
applying the large language model to the subsequent logged event to generate as an output a subsequent description;
applying the text embedding subcomponent of the embedding layer to the subsequent description to generate a subsequent fixed sized numerical vector as a subsequent text embedding;
applying the tokenizer of the embedding layer to the subsequent logged event to generate a subsequent token vector;
applying the subsequent learned embedding layer to the subsequent token vector to generate a subsequent fixed size numerical vector as a subsequent learned embedding;
combining the subsequent text embedding and the subsequent learned embedding to generate a subsequent d-dimensional numerical vector;
applying the classifier to compute a probability that the subsequent logged event is anomalous or normal based on the generated profile and the d-dimensional subsequent numerical vector for the subsequent logged event;
outputting a classification of the subsequent logged event based on the computed probability.

2. The computer device of claim 1, wherein the monitored system comprises at least one of a container, a pod, a virtual machine, (VM) or a physical computer.

3. The computer device of claim 1, wherein the encoding layer contextualizes the N logged events relative to one another by:
applying a multi-head attention layer to the N d-dimensional numerical vectors;
applying a first add and normalize layer to combine the N d-dimensional numerical vectors and the output of the multi-head attention layer through addition and normalization;
applying a feed forward layer to an output of the first add and normalize layer to reduce before expanding a dimensionality of the N d-dimensional attention vectors;
applying a second add and normalize layer to the output of the feed forward layer to incorporate both the output of the first add and normalize layer and an output of the feed forward layer through addition and normalization; and
outputting the profile comprising N d-dimensional profile vectors output by the second add and normalize layer.

4. The computer device of claim 1, wherein the activity log is generated by the monitored system and sent to the processor circuitry.

5. The computer device of claim 1, wherein:
each logged event of the N logged events is a string;
the tokenizer uses a map to tokenize the N logged events;
the map includes multiple strings;
each of the multiple strings is associated with a unique integer;
the tokenizer is configured to tokenize each of the logged events using the map by:
when a logged event is included in the map, tokenizing the logged event as the unique integer associated with the logged event; and
when the logged event is not included in the map, tokenizing the logged event as a default integer.

6. The computer device of claim 1, wherein the N text embeddings and the N learned embeddings are combined to generate the N d-dimensional numerical vectors by concatenating the N text embeddings and the N learned embeddings, such that each of the N learned embeddings is concatenated with a text embedding of the N text embeddings that is associated with a same logged event of the N logged events.

7. The computer device of claim 1, wherein:
the encoding layer includes at least two layers; and
the applying of the encoding layer to the generated N d-dimensional numerical vectors to generate the profile includes sequentially applying the at least two layers of the encoding layer.

8. The computer device of claim 1, wherein the classifier computes the probability based on:
the d-dimensional subsequent numerical vector; and
a head-wise weighted average performed on:
the N d-dimensional profile vectors; and
a head-wise softmax of a multi-head attention score of:
the d-dimensional subsequent numerical vector; and
each of the N d-dimensional profile vectors.

9. The computer device of claim 1, wherein the processor circuitry is further configured to train the machine learning model by:
receiving a training activity log including training logged events, wherein each of the training logged events is classified as anomalous or normal; and
modifying parameters of the embedding layer, the encoding layer, and the classifier to minimize a loss function based on the training logged events.

10. The computer device of claim 9, wherein the loss function is:
$$Loss ( \vec{x} , \vec{y} ) = \frac{1}{{n}^{2}} \cdot {\sum }_{i , j = 1}^{n} - {( {y}_{i} - {y}_{j} )}^{2} \cdot log ( \frac{1 + ( {x}_{i} - {x}_{j} ) \cdot ( {y}_{i} - {y}_{j} )}{2} + ε ) + γ \cdot Relu ( \frac{1}{{n}^{2}} \cdot {( {\sum }_{i = 1}^{n} {x}_{i} - {y}_{i} )}^{2} - {δ}^{2} ) ,$$
where ε∈(0,0.001), δ∈(0,0.25), γ≥0, \vec{x} is the computed probability and is a vector of length n, and y is the classification and is a vector of length n.

11. A method performed by processor circuitry for using a machine learning model stored in memory to detect anomalies in a monitored computer system, the method comprising:
receiving with the processor circuitry an activity log comprising records of logged events each representing at least one of a start of a process, a start of a thread, a termination of a process, a termination of a thread, or a start of a system call, wherein:
each of the logged events includes event data comprising at least one of an identifier of the event, a type of the event, a parent of the event, a path of a binary related to the event, a path of the parent, an identifier of a user associated with the event, parameters of the event, a return value of the event, a priority of the event, a duration of the event, or a start time of the event;
each of the logged events occurring during an initial activity period are identified as an initial activity log comprising N logged events;
each of the logged events occurring after the initial activity period are identified as a subsequent logged event;
the initial activity period comprises a predefined time duration; and
the machine learning model includes:
an embedding layer configured to combine an output of a large language model and an output of a learned embedding layer;
an encoding layer configured to output a profile representing the role of the monitored computer system based on an initial activity log; and
a classifier configured to classify an event as anomalous or normal;
applying with the processor circuitry the machine learning model to the received initial activity log by:
applying an embedding layer of the machine learning model to the initial activity log to generate N d-dimensional numerical vectors by:
applying the large language model to each of the N logged events to generate as an output N descriptions, wherein each of the N output descriptions represents a logged event of the N logged events that the output description was generated from;
applying a text embedding subcomponent of the embedding layer to the N descriptions to generate N fixed sized numerical vectors as N text embeddings, wherein each of the N fixed sized numerical vectors is a vector representation of a description of the N description that the fixed sized numerical vectors was generated from;
applying a tokenizer of the embedding layer to the N logged events to generate N vectors of tokens, wherein each token vector of the N vectors of tokens represents a logged event of the N logged events;
applying the learned embedding layer to the N vectors of tokens to generate N fixed size numerical vectors as N learned embeddings; and
combining the N text embeddings and the N learned embeddings to generate the N d-dimensional numerical vectors;
applying the encoding layer to the generated N d-dimensional numerical vectors to generate the profile by contextualizing the N logged events relative to one another;
applying the machine learning model to a subsequent logged event by:
applying the embedding layer to the subsequent logged event to generate a d-dimensional subsequent numerical vector by:
applying the large language model to the subsequent logged event to generate as an output a subsequent description;
applying the text embedding subcomponent of the embedding layer to the subsequent description to generate a subsequent fixed sized numerical vector as a subsequent text embedding;
applying the tokenizer of the embedding layer to the subsequent logged event to generate a subsequent token vector;
applying the subsequent learned embedding layer to the subsequent token vector to generate a subsequent fixed size numerical vector as a subsequent learned embedding; and
combining the subsequent text embedding and the subsequent learned embedding to generate a subsequent d-dimensional numerical vector;
applying the classifier to compute a probability that the subsequent logged event is anomalous or normal based on the generated profile and the d-dimensional subsequent numerical vector for the subsequent logged event;
outputting a classification of the subsequent logged event based on the computed probability.

12. The method of claim 11, wherein the monitored system comprises at least one of a container, a pod, a virtual machine, (VM) or a physical computer.

13. The method of claim 11, wherein the encoding layer contextualizes the N logged events relative to one another by:
applying a multi-head attention layer to the N d-dimensional numerical vectors;
applying a first add and normalize layer to combine the N d-dimensional numerical vectors and the output of the multi-head attention layer through addition and normalization;
applying a feed forward layer to an output of the first add and normalize layer to reduce before expanding a dimensionality of the N d-dimensional attention vectors;
applying a second add and normalize layer to the output of the feed forward layer to incorporate both the output of the first add and normalize layer and an output of the feed forward layer through addition and normalization; and
outputting the profile comprising N d-dimensional profile vectors output by the second add and normalize layer.

14. The method of claim 11, wherein the activity log is generated by the monitored system and sent to the processor circuitry.

15. The method of claim 11, wherein:
each logged event of the N logged events is a string;
the tokenizer uses a map to tokenize the N logged events;
the map includes multiple strings;
each of the multiple strings is associated with a unique integer;
the tokenizer is configured to tokenize each of the logged events using the map by:
when a logged event is included in the map, tokenizing the logged event as the unique integer associated with the logged event; and
when the logged event is not included in the map, tokenizing the logged event as a default integer.

16. The method of claim 11, further comprising the step of using the processor circuitry to combine the N text embeddings and the N learned embeddings to generate the N d-dimensional numerical vectors by concatenating the N text embeddings and the N learned embeddings, such that each of the N learned embeddings is concatenated with a text embedding of the N text embeddings that is associated with a same logged event of the N logged events.

17. The method of claim 11, wherein:
the encoding layer includes at least two layers; and
the applying of the encoding layer to the generated N d-dimensional numerical vectors to generate the profile includes sequentially applying the at least two layers of the encoding layer.

18. The method of claim 11, wherein the classifier computes the probability based on:
the d-dimensional subsequent numerical vector; and
a head-wise weighted average performed on:
the N d-dimensional profile vectors; and
a head-wise softmax of a multi-head attention score of:
the d-dimensional subsequent numerical vector; and
each of the N d-dimensional profile vectors.

19. The method of claim 1, further comprising the step of using the processor circuitry to train the machine learning model by:
receiving a training activity log including training logged events, wherein each of the training logged events is classified as anomalous or normal; and
modifying parameters of the embedding layer, the encoding layer, and the classifier to minimize a loss function based on the training logged events.

20. The method of claim 19, wherein the loss function is:
$$Loss ( \vec{x} , \vec{y} ) = \frac{1}{{n}^{2}} \cdot {\sum }_{i , j = 1}^{n} - {( {y}_{i} - {y}_{j} )}^{2} \cdot log ( \frac{1 + ( {x}_{i} - {x}_{j} ) \cdot ( {y}_{i} - {y}_{j} )}{2} + ε ) + γ \cdot Relu ( \frac{1}{{n}^{2}} \cdot {( {\sum }_{i = 1}^{n} {x}_{i} - {y}_{i} )}^{2} - {δ}^{2} ) ,$$
where ε∈(0,0.001), δ∈(0,0.25), γ≥0, \vec{x} is the computed probability and is a vector of length n, and y is the classification and is a vector of length n.
